(19) United States
(12) Patent Application Publication
(10) Pub. No.: US 2012/0125266 A1
(43) Pub. Date: May 24, 2012

(54) Launch Apparatus for a Pet Toy

(75) Inventor: Felix A. Ying, Pueblo, CO (US)

(73) Assignee: TIMBERWOLF HOLDINGS LLC, Pueblo, CO (US)

(21) Appl. No.: 12/950,681

(22) Filed: Nov. 19, 2010

(51) Int. Cl. A01K 29/00

(52) U.S. Cl. 119/707

(57) ABSTRACT

A launch apparatus for a pet toy comprises a launcher and a toy. The launcher further comprises a hook integral with a strap, which strap is integral with a strap connector, which strap connector is integral with a grip, which grip is integral with a shield. The toy further comprises and is integral with a loop; wherein the loop releasably engages the hook of the launcher. Preferably, the loop is located on a ventral surface of and toward a leading edge of the toy. A user launches the toy by placing the loop of the toy over the hook of the launcher, stretching the strap to build elastic energy in the strap, and releasing the toy.

### BACKGROUND OF THE INVENTION

1. Field of the Invention

The present invention is a launch apparatus for a pet toy; wherein a user plays with, exercises or trains a pet, in particular a dog, by using the launch apparatus to launch or throw the pet toy to be fetched or retrieved and returned by the pet to the user.

2. Description of Related Art Including Information Disclosed Under 37 CFR 1.97 and 37 CFR 1.98

A myriad of pet toys made from nylon, cotton, hemp, plastic, latex, PET or similar materials have been on the market for quite some time. These toys are available in a variety of shapes, sizes, and designs and may or may not be stuffed with a filling material, such as PET or similar spun fiber, and may or may not include a plastic squeaker. Many animals or pets, in particular dogs, enjoy fetching these types of toys.

Pet owners or users commonly throw the toys some distance for the animal to retrieve and possibly return to the owner. The distance and frequency that most pet owners can throw the toy is very limited due to the physical strength of the pet owner and the generally lightweight of the pet toy itself. Many owners, therefore, cannot exert sufficient energy to sustain a fetch or retrieve an return game with their pets and give up on throwing toys to their pets or merely throw the toy a short distance reducing the interaction they have with their pets.

Accordingly, an improved device or launch apparatus is needed to more easily throw a pet toy a greater distance by a user than the user can throw by hand to create a more sustainable and improved fetching or retrieval and return game and, more importantly, to improve play, exercise and training interaction between pets and their owners.

There are various launch apparatuses for both human and animal toys known in the prior art. Among these are U.S. Pat. No. 4,997,401 issued 5 Mar. 1991 by Rose et al. for Aerial Toy discloses an aerial, glider type toy that is launched by an elastic device which is releasably connected to a hook member on the body of the toy.

U.S. Pat. No. 5,194,033 issued 16 Mar. 1993 by Wright for Projectable Toy Stuffed Animal discloses a stuffed animal toy that is structured for being projected through the air; wherein an elongate tail projecting rearward from the body of the toy is extendable and has an elastic element therein which is used to launch the toy.

U.S. Pat. No. 5,282,453 issued 1 Feb. 1994 by Chia for Toy Slingshot Device for Launching a Projectile discloses a slingshot device for a missile; wherein a launching wedge affixed to a free end of an elastic strap for releasably coupling the free end of the elastic strap with the missile and the other end of the elastic strap is connected to a launcher, such that upon drawing the free end of the elastic strap back away from the launcher and then releasing the free end, the missile is launched.

U.S. Pat. No. 5,863,250 issued 26 Jan. 1999 by Harris for Aerial Toy discloses an aerial toy that is adapted to be launched into the air using an elastomeric band; wherein the toy has a notch and appendage on the underside of the nose portion of the aerial toy, which notch and appendage are adapted for receiving the elastomeric band of a launcher.

U.S. Pat. No. 6,443,792 issued 3 Sep. 2002 by Forti et al. for Mechanically Launched Monowing Toy discloses a flying toy with a wing having a leading edge, a first end, and a second end; wherein a ballast element is coupled to the first end of the wing, and a launcher receiver element that receives a launcher is coupled to the ballast element.

U.S. Pat. No. 6,500,042 issued 31 Dec. 2002 by LaPointe for Foam Trajectory Toys discloses a projectile toy having an elongate projectile member having a body portion connected to a nose portion; wherein a hook device is connected to the body portion near the nose potion, and an elastomeric tether for engaging the hook device can be stretched and released causing the projectile member to launch with the nose portion in front.

U.S. Pat. No. 6,595,160 issued 22 Jul. 2003 by Williamson for Dog Exercise Apparatus and Method discloses a tennis ball throwing apparatus to exercise a dog, which apparatus includes a sling arrangement that permits easily throwing of balls a long distance.

US Patent Application 2008/0156307 published 3 Jul. 2008 by Myers for Object Launcher and Method of Launching Object discloses a hand-held launcher for launching an object that includes a handle and a frame fixedly attached proximate the handle and extending forwardly from the handle; elastic tubing that is attached to a forward end of the frame; and a hook that is attached to an object to be launched where the hook engages the tubing when the tubing is positioned into a stretched position and wherein the hook is capable of being released from the tubing during launching.

### BRIEF SUMMARY OF THE INVENTION

The present invention is a launch apparatus for a pet toy comprising a launcher and a toy. The launcher further comprises a hook, which is integral with a strap, which strap is integral with a strap connector, which strap connector is integral with a grip, which grip is integral with a shield. Preferably, an end of the strap is integral with the hook and another end of the strap is integral with the strap connector.

The toy further comprises and is integral with a loop; wherein the loop releasably engages the hook of the launcher. Preferably, the loop is located on a ventral surface of the toy; and further preferably, the loop is located toward a leading edge of the toy. Alternatively, the toy may further comprise a tail and/or at least a wing.

A user using the launcher of the present invention launches the toy by placing the loop of the toy over the hook of the launcher, stretching the strap to build elastic energy in the strap to a desired elastic tension capacity, and releasing the toy.

### BRIEF DESCRIPTION OF THE SEVERAL VIEWS OF THE DRAWING(S)

FIG. 1 is perspective view of a launcher of the present invention.

FIG. 2 is a perspective view of a toy of the present invention.

FIG. 3 is perspective view of a launcher and a toy of the present invention primed and ready to be launched.

### LIST OF REFERENCE NUMERALS

2 launcher
4 grip
6 strap connector
8 shield
10 strap
12 hook
14 toy
16 body
18 tail
20 loop
22 wings

### DETAILED DESCRIPTION OF THE INVENTION

A launch apparatus for a pet toy of the present invention comprises a hand-held launcher that releasably interfaces with a launchable or throwable pet toy. To use the launcher of the present invention, a user releasably attaches the toy to the launcher and employs the elastic energy of the launcher to launch the toy.

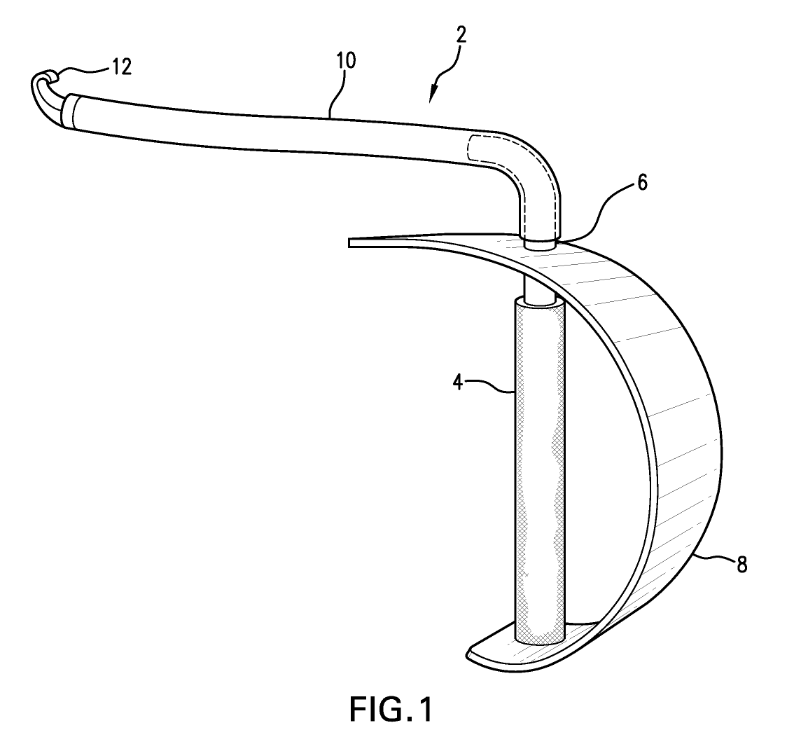

A launcher 2 of the present invention is show in FIG. 1. The launcher 2 comprises a grip 4 interrelated with a shield 8. Integral with the grip 4 is a strap connector 6. An end of a strap 10 is integral with the strap connector 6 and an opposite end of the strap 10 is integral with a hook 12.

The grip 4 of the launcher 2 is of a size sufficient to be held by a user's hand and may be tubular-shaped or any other shape suitable for being held in the user's hand. The grip 4 may be hollow or solid and may be made of any suitable material, such as plastic, wood, metal or the like, that has sufficient strength to withstand the forces applied to the launcher 2 when in use. The grip 4 may be shaped or molded with finger recesses to more readily conform to and be grasped by a user's hand. The grip 4 may have a texturized surface to afford, or be covered with foam, neoprene, or any other suitable material that affords, comfort and/or stability the to the user's grasp on the grip 4.

The grip 4 is integral with a shield 8; wherein the shield affords protection to the user's hand when the launcher 2 is in use. The shield may be of any suitable configuration, such as a partial sphere, or other convex, cubic or rectangular shape, and may be made of suitable material to afford protection to the user's hand, such as plastic or metal, when the launcher 2 is in use. As shown in FIG. 1, preferably the shield 8 is a partial sphere in shape and attaches to a top end and a bottom end of the grip 4.

As shown in FIG. 1, a strap connecter 6 extends from the junction of the top end of the grip 4 and the shield 8. The strap connector 6 preferably is constructed such that it emerges at a 0° angle from the top end of the grip 8 and then turns at an angle of from approximately 45° to approximately 90° to a central, longitudinal axis of the grip 8 and extends rearward away from a front of the shield 8. The strap connector 6 may be made of any suitable material, such as metal, wood, plastic or the like.

The grip 4, shield 8 and strap connector 6 of the launcher 2 may be comprised of separate, integral components of any suitable material, such as metal, wood, plastic or the like. Preferably, the grip 4, shield 8 and strap connector 6 of the launcher 2 are an integral, singular component made of injection-molded plastic or any other suitable material that may be crafted into an integral, singular component.

As shown in FIG. 1, the strap connector 6 is integral with a first end of a strap 10. A second end of the strap 10 is integral with a hook 12. The strap 10 may be of any suitable material capable of building, storing and releasing elastic energy, such as an elastic band, rubber tubing, latex tubing or the like. The hook 12 may be made of any suitable, rigid material, such as metal, plastic or the like, that will retain its shape and not deform or break when subjected to load forces. The hook 12 and may be configured in any suitable shape or size such that the hook 12 releasably engages with a loop 20 of a toy 14.

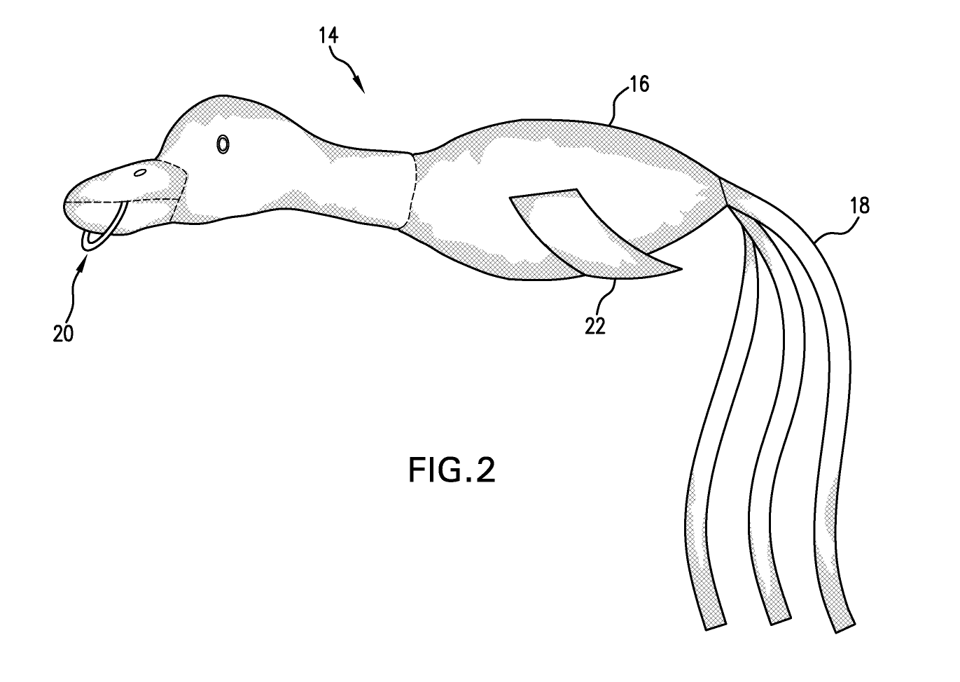

A toy 14 of the present invention is shown in FIG. 2. The toy 14 may be made of any suitable material that is durable and will hold up to wear and tear endured during use, and that is yieldable enough to not damage a pet's mouth and teeth when the toy 14 is held in the pet's mouth, such as nylon, cotton, hemp, plastic, latex, PET or the like. The toy 14 may be of any shape or appearance desired by a user, such as a person, animal, ball, bone or other object.

The toy 14 comprises a body 16 and optionally may comprise a head 18 integral with the body 16. The toy 14 further comprises an optional, but preferable, tail 18 integral with the body 16.

The toy 14 further comprises a loop 20 integral with the toy 14. The loop 20 may be located at a front end of the body 16 and may be placed on either a leading edge of the body, or a dorsal or ventral surface of the body 16. Preferably, the loop 20 is placed on a ventral surface of the body 16 and toward the front end of the body 16 to achieve a most effective launch by a launcher 2 of the present invention. The loop 20 may be made of any suitable material capable of sustaining load forces applied to the loop 20, such as nylon, cotton, hemp, rubber, plastic or the like.

Preferably, the hook 12 is integral with the strap 10. Alternatively, however, the hook 12 may be integral the toy 14 and the loop 20 may be integral with the strap 10. It is preferable that the hook 12 be integral with the strap 10 to prevent the pet from harming itself with or ingesting the hook 12 when retrieving and returning the toy 14 to the user. It is further preferable that the hook 12 be integral with the strap 10, because when the toy 14 is launched by the launcher 2 of the present invention, a greater flight distance of the toy 14 is achieved, than if the hook 12 were integral with the toy 14.

The toy 14 optionally, but preferably, may comprise a tail 18. The tail 18 is integral with the body 16 of the toy 14 and aids in flight arc, distance, duration and stability of the toy 14 after it is launched by the launcher 2 of the present invention. The tail 18 may be a unitary tail or a multi-part tail. The tail 18 may be made of any suitable material, such as nylon, cotton, hemp, rubber, plastic, feathers or the like. The tail 18 may be either rigid or flexible as desired by the user, but the tail 18 should have sufficient drag to allow the toy 14 to attain a true flight arc when launched by the launcher 2 of the present invention. The tail 18 may be integral with and a unitary part of the body 16 of the toy 14, or it may be integral with, but a separate part of, the body 16 of the toy 14.

The toy 14 optionally may comprise at least a wing or fin 22; wherein the wings 22 are integral with the body 16 of the toy 14 and may be placed upon the body 16 as may be desired, such as laterally, ventrally, or dorsally, to aid in flight arc, distance, duration and stability of the toy 14 after it is launched by the launcher 2 of the present invention. The wings 22 may be made of any suitable material capable of aiding in flight arc, distance, duration and stability of the toy 14, such as plastic, fabric, wood, metal or the like.

Preferably, the toy 14 is weight forward in construction. Further preferably, a front half of a total length of the body 16 of the toy 14 comprises approximately 60% of the total weight of the toy 14. Further preferably, a weight forward area of the toy 14 of approximately a front third of the total length of the body 16 of the toy 14 has a preferable percentage ratio of forward weight of the body 16 of the toy 14 to the total weight of the toy 14 from about 20:100 to about 30:100. The toy 14 of the present invention preferably is weight forward in construction to achieve optimal flight arc, distance, duration and stability of the toy 14 when launched by the launcher 2 of the present invention.

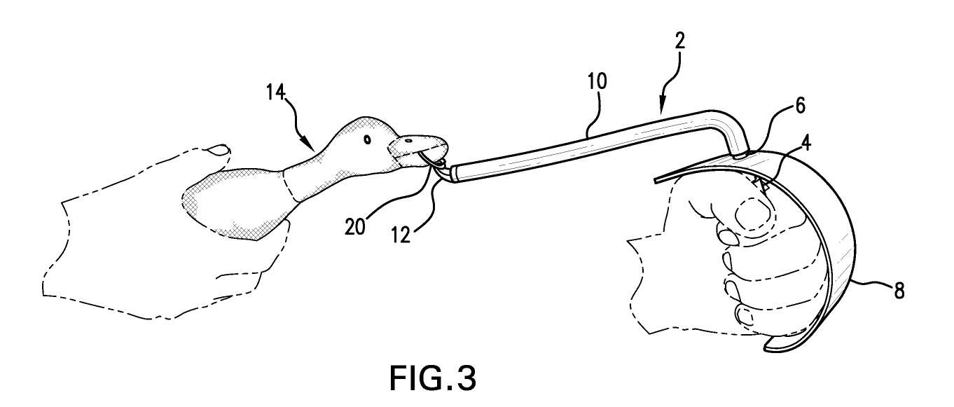

A user using the launcher 2 of the present invention can launch the toy 14 a great distance from approximately 50′ to approximately 120′ without substantial or exhausting effort by the user. To operate the launcher 2 of the present invention, as shown in FIG. 3, first the user, according to the user's preference, grasps in a hand the launcher 2 by the grip 4 with the shield 8 in a position such that the shield 8 covers the user's hand and faces away from the user. Second, the user grasps the toy 14 with another hand and places the loop 20 of the toy 14 over the hook 12 of the launcher 2. Third, the user preferably fully extends the arm and hand grasping the launcher 2 ventrally forward and upward at anywhere from at least approximately parallel to approximately 90° perpendicular to a surface of the ground. Fourth, the user draws the hand grasping the toy 14 along the same plane as the hand and arm grasping the launcher 2, but in a direction opposite from the grip 4, to stretch the strap 10 to build elastic energy in the strap 10 to a desired elastic tension capacity. Fifth, the user releases the toy 14, thus launching the toy 14 with the launcher 2 of the present invention.

When the user releases the toy 14, the strap 10 rapidly contracts to its original, static length and transfers the elastic energy built-up and stored in the strap 10 to the toy 14; whereby the toy 14 is thrust forward and launched at a high velocity from the launcher 2 of the present invention.

As the toy 14 moves forward in its flight, the loop 20 is released from the hook 12 and the toy 14 is freed and propelled forward. A distance that the toy 14 can travel after being launched with the launcher 2 of the present invention is easily controlled by the user through limiting or extending the length to which the strap 10 is stretched and the concomitant amount of elastic energy created thereby and stored in the strap 10 for transfer to the toy 14 upon its release and launch.

The present invention is described with reference to specific embodiments; however, it is understood that modifications and variations of the present invention are possible without departing from the scope of the invention, which is defined by the claims set forth below. Unless defined otherwise, all technical and scientific terms used herein have the same meaning as commonly understood by one of ordinary skill in the art to which this invention belongs.

The invention claimed is:

1. A launch apparatus for a pet toy comprising:
a. A launcher, further comprising:
i. A hook, integral with;
ii. A strap, integral with;
iii. A strap connector, integral with;
iv. A grip, integral with; and
v. A shield; and
b. A toy, further comprising and integral with a loop; wherein the loop releasably engages the hook of the launcher.

2. The invention of claim 1; further wherein an end of the strap is integral with the hook and another end of the strap is integral with the strap connector.

3. The invention of claim 1; further wherein the loop is located on a ventral surface of the toy.

4. The invention of claim 3; further wherein the loop is located toward a leading edge of the toy.

5. The invention of claim 1; further wherein the toy further comprises a tail.

6. The invention of claim 1; further wherein the toy further comprises at least a wing.

7. A launch apparatus for a pet toy comprising:
a. A launcher, further comprising:
i. A hook, integral with;
ii. A strap, integral with;
iii. A strap connector, wherein an end of the strap is integral with the hook and another end of the strap is integral with the strap connector, further wherein the strap connector is integral with;
iv. A grip, integral with; and
v. A shield; and
b. A toy, further comprising:
i. A body, integral with;
ii. A tail; and
iii. A loop, wherein the loop is integral with and located on a ventral surface and toward a leading edge of the body of the toy, further wherein the loop releasably engages the hook of the launcher.
